(19) United States
(12) Patent Application Publication
(10) Pub. No.: US 2010/0057958 A1
(43) Pub. Date: Mar. 4, 2010

(54) APPARATUS OF DIGITAL MAC FOR IEEE 802.15.4 SYSTEM AND SYSTEM THEREOF

(76) Inventors: Dong Sun Kim, Gyeonggi-do (KR); Tae Ho Hwang, Seoul (KR); Yeon Kug Moon, Seoul (KR); Kwang Ho Won, Gyeonggi-do (KR)

Correspondence Address: North Star Intellectual Property Law, PC, P.O. Box 34688, Washington DC, DC, 20043, US

(21) Appl. No.: 12/200,439

(22) Filed: Aug. 28, 2008

(51) Int. Cl. G06F 13/42

(52) U.S. Cl. 710/106

(57) ABSTRACT

There is provided a digital MAC apparatus for an IEEE 802.15.4 based communication system, which is implemented in hardware. The digital MAC apparatus having a processor of a Wireless Personal Area Network (WPAN) communication system and a data bus transferring data includes a frame generating unit generating and outputting a frame on the basis of input data; a frame parsing unit parsing an input frame input through the data bus, and generating and outputting a control signal or transmission and receipt data; and a controller operating at least one of the frame generating unit and the frame parsing unit according to the generated control signal, and communicating the output frame or data with the processor according to the operation.

### TECHNICAL FIELD

The present disclosure relates to an implementation of a Media Access Control (MAC) layer of a communication system, and in particular, to a digital MAC apparatus for an IEEE 802.15.4 based communication system, which is implemented in hardware.

### BACKGROUND

In IEEE 802.15.4 based Wireless Personal Area Network (WPAN) technology, it is an important issue to make a physical layer operate for a longer time under a power supply environment having a limited capacity. For this, it is important to minimize power consumption according to a transmission and receipt of data and an execution of other applications.

A power consumed by an operation of a processor occupies a considerable portion of a power consumed in the above-described communication system. Since the processor must construct frames for transceiving data and perform an encoding process and the like according to needs, it has a tendency that rapidly increases an amount of an operation.

In a related art IEEE 802.15.4 based chipset, an MAC module provides Cyclic Redundancy Check (CRC), Advanced Encryption Standard (AES) based encoding module and timer functions in order to reduce an operation amount of a processor, but the processor must directly control each function according to a signal processing flow for providing the functions. That is, when there is a necessary operation, a high-performance processor performs an operation using each of function blocks, such as an accelerator.

FIG. 1 is a block diagram of the related art IEEE 802.15.4 based chipset. Referring to FIG. 1, each of functions provided from an MAC module is added to an MAC function block. That is, the MAC function block is used as a function extension block by a processor to thereby provide an MAC function.

However, since an MAC implementation by the related art described above necessarily requires a control of the processor, the processor requires an internal interface such as an interrupt controller so that the MAC implementation must accompany additional designs according to each state of the processor.

Moreover, since only a portion of MAC functions is implemented in hardware of a function block type, the MAC function block has difficulty in organically operating with software so that it is limited in an actual use.

In such a related art, since the processor must control each block included in the MAC function block, although the each block of the MAC function block is used, it is difficult to reduce a size of a built-in program memory.

Furthermore, since the processor must check a state of the each block of the MAC function block, efficiency for a time management of the processor is reduced.

### SUMMARY

Accordingly, the present disclosure provides a digital MAC apparatus which is implemented in hardware to perform an MAC operation, thereby minimizing an operation amount of a processor.

According to an aspect, there is provided a digital Media Access Control (MAC) apparatus including a processor of a Wireless Personal Area Network (WPAN) communication system and a data bus transferring data, the digital MAC apparatus including: a frame generating unit generating and outputting a frame on the basis of input data; a frame parsing unit parsing an input frame input through the data bus, and generating and outputting a control signal or transmission and receipt data; and a controller operating at least one of the frame generating unit and the frame parsing unit according to the generated control signal, and communicating the output frame or data with the processor according to the operation.

According to another aspect, there is provided a Wireless Personal Area Network (WPAN) communication system, including: a digital Media Access Control (MAC) apparatus parsing an input frame to generate a control signal, and performing an MAC operation according to the generated control signal; and a processor performing control to input data to the digital MAC apparatus or to output data to the digital MAC apparatus.

According to another embodiment, there is provided a method for operating and managing a digital Media Access Control (MAC) apparatus, including: parsing an input frame to generate a control signal; receiving transmission and receipt data; generating a frame on the basis of the transmission and receipt data according to the generated control signal; and outputting the generated frame.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a related art IEEE 802.15.4 based chipset;

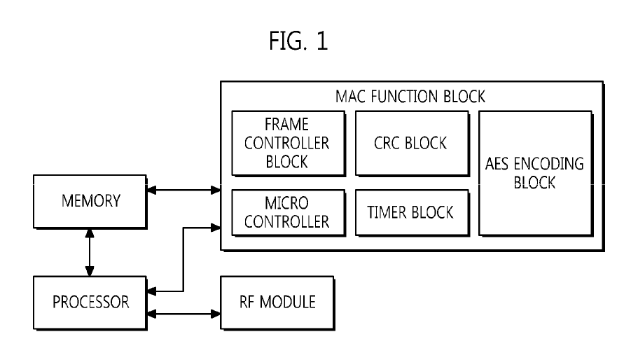

FIG. 2 is a block diagram of a digital MAC apparatus according to an exemplary embodiment;

FIG. 3 is an internal block diagram of a frame manager of FIG. 2; and

FIG. 4 is an internal block diagram of a controller of FIG. 2.

### DETAILED DESCRIPTION OF EMBODIMENTS

An exemplary embodiment relates to a digital based MAC apparatus which is implemented in hardware in order to reduce an operation amount of a processor in an IEEE 802.15.4 based WPAN communication system, and to a communication system using the same.

In the related art digital MAC technology, each function block (e.g., an encoding block, a CRC block, and a frame control block) operates according to control of a processor of a communication system. On the other hand, in the digital MAC apparatus according to an exemplary embodiment, a processor of a communication system controls only an input/output of main data, hardware can automatically control and perform operations for other overall MAC functions through an analysis of a data frame structure and the like.

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

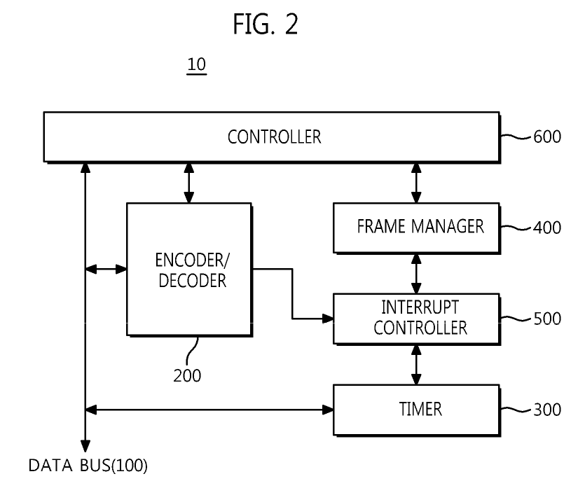

FIG. 2 is a block diagram of a digital MAC apparatus according to an exemplary embodiment.

Referring to FIG. 2, a digital MAC apparatus 10 according to an exemplary embodiment includes a data bus 100, an encoder/decoder 200, a timer 300, a frame manager 400, an interrupt controller 500, and a controller 600. The data bus 100 connects the other elements of a communication system (e.g., a processor, a memory and the like) with the digital MAC apparatus 10 and transfers data. The encoder/decoder 200 encodes or decodes data. The frame manager 400 generates or parses frames for communication. The interrupt controller 500 controls an interrupt. The controller 600 controls the data bus 100, the encoder/decoder 200, the timer 300, the frame manager 400, the interrupt controller 500 and the controller 600.

More specifically, the data bus 100 transfers data between the each element of the communication system including the digital MAC apparatus 10 and the digital MAC apparatus 10. Moreover, the data bus 100 transfers data between the elements 200, 300, 400, 500 and 600 of the digital MAC apparatus 10, and also transfers data between the elements 200, 300, 400, 500 and 600 and the each element of the communication system (e.g., the processor, the memory and the like).

The encoder/decoder 200 receives data from the controller 600, and encodes or decodes the received data to output them to the controller 600. The encoder/decoder 200 may be implemented based on hardware using an encoding algorithm such as AES, Academy Research Institute and Agency (ARIA) and Data Encryption Standard (DES).

Accordingly, the encoder/decoder 200 can perform a Cipher Block Chaining mode, a Counter (CTR) mode, a CCM (CTR+CBC−MAC) mode and the like. Moreover, the encoder/decoder 200 receives information (hereinafter, referred to as information necessary to encoding/decoding) such as encoding mode information, an encoding key, a chain value, a mask value and a pad length necessary for encoding/decoding from the processor of the communication system.

That is, the encoder/decoder 200 can perform encoding or decoding according to the control signal of the controller 600, and can also receive the information necessary for encoding/decoding through the data bus 100 from the processor of the communication system.

The timer 300 detects a violation of an input frame or input data by detecting the time difference between data input from the data bus 100.

The timer 300 may be configured with four inter-symbol timers.

The frame manager 400 generates frames for MAC communication, and also parses an input frame.

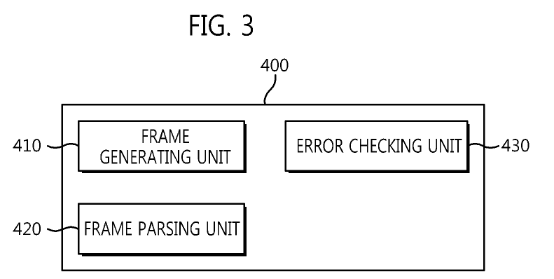

FIG. 3 is an internal block diagram of the frame manager of FIG. 2. Hereinafter, the frame manager 400 will be described in detail below with reference to FIG. 3.

Referring to FIG. 3, the frame manager 400 may include a frame generating unit 410, a frame parsing unit 420, and an error checking unit 430.

The frame generating unit 410 receives transmission/receipt data for wireless communication (hereinafter, referred to as transmission/receipt data), and generates a frame for the MAC communication using the received transmission/receipt data. Thereafter, the frame generating unit 410 outputs the generated frame to the controller 600.

The frame parsing unit 420 parses the received frame, and generates a control signal or extracts the transmission/receipt data. That is, the frame parsing unit 420 parses the received frame, obtains information of an operation which the digital MAC apparatus 10 should performs, and generates the control signal according to the obtained information. For this, the frame parsing unit 420 parses a structure of a frame, a header field of the frame or a payload field of the frame, and generates the control signal.

Due to the generation of the control signal by the frame parsing, the digital MAC apparatus 10 can generate the control signal by itself and perform an MAC operation without receiving the control signal for the MAC operation from the processor. Therefore, an operation amount of the processor of the communication system can considerably reduced, and consequently an amount of the power consumption of the communication system can also be reduced by the reduction of the operation amount of the processor.

The error checking unit 430 checks whether an error occurs in a frame which is transmitted or received through the MAC communication. That is, the error checking unit 430 inserts error detection information in a frame generated by the frame generating unit 410 or checks whether a communication error occurs in a frame which the frame parsing unit 420 receives. The error checking unit 430 performs an error check based on CRC.

The controller 600 operates the encoder/decoder 200, the frame generating unit 410 and the frame parsing unit 420 sequentially or simultaneously according to the received control signal, and transfers the generated or output frame or data to the processor of the communication system according to the operation.

At this point, the control signal which the controller 600 receives may be a control signal generated according to a result of the frame parsing of the frame parsing unit 420, and may also be a specific control signal received from the processor of the communication system.

That is, in a case of a common MAC operation, the controller 600 operates on the basis of the control signal generated by the frame parsing unit 420 (i.e., in a case where the control of the processor of the communication system is unnecessary). However, in a case such as the encoding/decoding of data, the mode change of the encoding/decoding and the like, since the controller 600 operates based on the operation request of the processor of the communication system, it can receive the specific control signal from the processor of the communication system.

In more detail, a general MAC function such as error (CRC) check, MAC frame generation and parsing and state machine management can be executed based on the control signal generated by the frame parsing unit 420. A function such as encoding/decoding control, acknowledge (ACK) communication, address allotment and management, network topology control, transmission band control, channel band control and transfer rate control can be executed based on the specific control signal received from the processor.

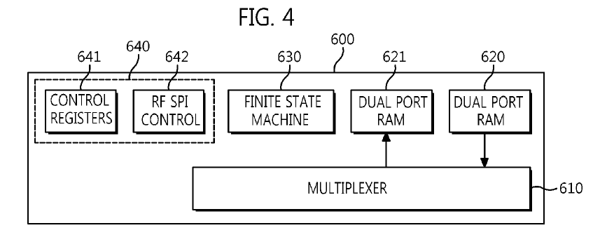

FIG. 4 is an internal block diagram of the controller of FIG. 2. Hereinafter, the controller 600 will be described in detail below with reference to FIG. 4.

Referring to FIG. 4, the controller 600 may include a multiplexer block 610, a first memory block 620, a second memory block 621, a finite state machine block 630, and a control block 640.

The multiplexer block 610 has the configuration of a common multiplexer, and exchanges data with the encoder/decoder 200, the frame generating unit 410 and the frame parsing unit 420 simultaneously or sequentially. Particularly, to perform the input/output of data without data collision, the multiplexer block 610 is connected with the first and second memory blocks 610 and 621 being two memories and exchanges data.

The first and second memory blocks 610 and 621 store data input from the multiplexer block 610, or output the stored data to the multiplexer block 610.

That is, to minimize the input/output collision of the multiplexer block 610, the first memory block 620 may store input data and the second memory block 621 may store output data. Alternatively, an exemplary embodiment uses the first and second memory blocks 610 and 621 as a plurality of memory banks without the difference between the input data and the output data, thereby preventing data collision.

The memory blocks 620 and 621 may be a dual port memory (Dual port Random Access Memory (DPRAM)) where a plurality of reading operations and writing operations can simultaneously be performed.

The finite state machine block 630 maintains state information of the each element 200, 300, 400 and 500 of the digital MAC apparatus 10. Moreover, the finite state machine block 630 may transfer the state information of the each element 200, 300, 400 and 500 to the interrupt controller 500.

The control block 640 controls a data path multiplexer in order to exchange data with the encoder/decoder 200, the frame generating unit 410 and the frame parsing unit 420 on the basis of the control signal and the state information of the each element 200, 300, 400 and 500 maintained by the finite state machine block 630. The control block 640 may include a control register 641 and a Radio Frequency (RF) Serial Peripheral Interface (SPI) controller 642 performing a sate based packet detection.

The interrupt controller 500 generates the operation information of the digital MAC apparatus 10, and transfers the generated operation information to the processor of the communication system. That is, the interrupt controller 500 can generate the operation information of the digital MAC apparatus 10 on the basis of the state information of the encoder/decoder 200, the frame generating unit 410 and the frame parsing unit 420 received from the controller 600.

Hereinafter, the WPAN communication system including the digital MAC apparatus 10 will be described below.

The WPAN communication system according to an exemplary embodiment parses an input frame and generates the control signal. The WPAN communication system may include the digital MAC apparatus 10 performing the MAC operation according to the generated control signal, and the processor performing control to exchange data with the digital MAC apparatus 10.

The processor controls the input/output of data on the digital MAC apparatus 10.

Furthermore, the processor does not transfer the control signal to the digital MAC apparatus 10 in the common MAC operation. However, in a specific case such as the change of an encoding mode, the processor can transfer the specific control signal to the digital MAC apparatus 10 to thereby control the digital MAC apparatus 10.

Moreover, the processor can send the above-described control information for controlling the digital MAC apparatus 10 or exchange data with the digital MAC apparatus 10 using the operation information transmitted by the interrupt controller 500.

Since the functions of the digital MAC apparatus 10 and the data bus 100 are the same as the functions which have been described above with reference to FIGS. 2 to 4, their description will be omitted.

The following Table 1 represents that a processor occupying rate in the WPAN communication system including the digital MAC apparatus is compared with a processor occupying rate in the related art WPAN communication system using software.

TABLE 1

| | | Using digital |
|---|---|---|
| MAC functions | Using software | MAC |
| Acknowledgment | 3% | 0% |
| CRC | 3% | 0% |
| Address recognition | 8% | 5% |
| MAC frame parsing/generation | 22% | 6% |
| CSMA-CA | 3% | 3% |
| Super frame management | 10% | 7% |
| MAC core (state machine) | 16% | 16% |
| MAC primitives | 17% | 17% |
| Physical layer access | 10% | 2% |
| AES-128 | 8% | 0% |
| Total | 100% | 56% |

As shown in the Table 1, in a case that uses the digital MAC apparatus 10 according to an exemplary embodiment, it can be seen that an operation amount of the processor is considerably reduced in ACK, CRC, address recognition, frame generation and parsing, super frame management, physical layer access and AES encoding.

Hereinafter, a method for operating and managing the digital MAC apparatus 10 according to an exemplary embodiment will be described in detail below.

The frame parsing unit 420 parses an input frame and generates the control signal. The controller 600 receives transmission/receipt data.

At this point, the step generating the control signal can be executed through any one or combination of a step parsing the structure of the input frame to generate the control signal, a step parsing the header field of the input frame to generate the control signal and a step parsing the payload field of the input frame to generate the control signal.

Subsequently, the controller 600 controls the frame generating unit 410 in order to perform framing on the transmission/receipt data according to the control signal generated by the frame parsing unit 420. Such a framing step includes changing a signal transferred from the physical layer into a frame as well as changing packet data transferred from a network layer into a frame.

Thereafter, the controller 600 outputs the generated frame to thereby transfer it to the processor of the communication system, and thus performs control for the communication system to perform wireless communication.

An exemplary embodiment can reduce an operation amount of an internal processor by implementing the MAC apparatus in hardware and performing the MAC operation without control of the processor, thereby minimizing power consumption according to processing.

An exemplary embodiment can perform a high-speed MAC operation because of implementing most of the MAC functions in hardware.

In an exemplary embodiment, the processor does not require an internal interface such as the interrupt controller because the interrupt controller is embedded in the MAC apparatus, and thus an additional design of the processor is not required.

In an exemplary embodiment, the processor need not check a state of each block of the MAC function block because the finite state machine block is embedded in the MAC apparatus, and thus efficiency for a time management of the processor increases.

An exemplary embodiment can reduce the number of the program memories of the processor because the processor need not control each block of the MAC function block, thereby reducing the production cost of the communication system.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A digital Media Access Control (MAC) apparatus comprising a processor of a Wireless Personal Area Network (WPAN) communication system and a data bus transferring data, the digital MAC apparatus comprising:
a frame generating unit generating and outputting a frame on the basis of input data;
a frame parsing unit parsing an input frame input through the data bus, and generating and outputting a control signal or transmission and receipt data; and p1 a controller operating at least one of the frame generating unit and the frame parsing unit according to the generated control signal, and communicating the output frame or data with the processor according to the operation.

2. The digital MAC apparatus of claim 1, wherein the frame parsing unit parses at least one of a structure, header field and payload field of the input frame and generates the control signal.

3. The digital MAC apparatus of claim 1, wherein the controller operates at least one of the frame generating unit and the frame parsing unit according to a specific control signal received from the processor.

4. The digital MAC apparatus of claim 3, wherein the specific control signal is a control signal on at least one of encoding/decoding control, address allotment and management, network topology control, transmission band control, channel band control and transfer rate control.

5. The digital MAC apparatus of claim 1, further comprising an interrupt controller generates operation information of the digital MAC apparatus and transfers the generated operation information to the processor.

6. The digital MAC apparatus of claim 5, wherein the interrupt controller generates the operation information on the basis of state information of an encoder/decoder, the frame generating unit and the frame parsing unit received from the controller.

7. The digital MAC apparatus of claim 1, further comprising an encoder/decoder encoding or decoding input data and outputting the encoded or decoded data.

8. The digital MAC apparatus of claim 7, wherein the encoder/decoder performs encoding or decoding with any one encoding algorithm of Advanced Encryption Standard (AES), Academy Research Institute and Agency (ARIA) and Data Encryption Standard (DES).

9. The digital MAC apparatus of claim 7, wherein the encoder/decoder changes an encoding or decoding mode according to mode changing information from the processor.

10. The digital MAC apparatus of claim 1, further comprising an error checking unit checking a communication error on the input frame or the frame generated by the frame generating unit.

11. The digital MAC apparatus of claim 1, further comprising a timer detecting a time difference between data input from the data bus.

12. The digital MAC apparatus of claim 1, wherein the controller comprises:
a multiplexer block exchanging data with any one of the frame generating unit and the frame parsing unit;
a first and second memories storing data input from the multiplexer block and data output to the multiplexer block;
a finite state machine block maintaining state information of any one of the frame generating unit and the frame parsing unit; and
a control block controlling the multiplexer block according to the state information maintained by the finite state machine block.

13. The digital MAC apparatus of claim 12, wherein the first and second memories are a dual port memory.

14. A Wireless Personal Area Network (WPAN) communication system, comprising:
a digital Media Access Control (MAC) apparatus parsing an input frame to generate a control signal, and performing an MAC operation according to the generated control signal; and
a processor performing control to input data to the digital MAC apparatus or to output data to the digital MAC apparatus.

15. The WPAN communication system of claim 14, wherein the digital MAC apparatus comprises:
a frame generating unit generating and outputting a frame on the basis of input transmission and receipt data;
a frame parsing unit parsing the input frame, and generating and outputting the control signal or transmission and receipt data; and
a controller operating at least one of the frame generating unit and the frame parsing unit according to the control signal, and communicating the output data with the processor according to the operation.

16. The WPAN communication system of claim 15, wherein the frame parsing unit parses at least one of a structure, header field and payload field of the input frame and generates the control signal.

17. A method for operating and managing a digital Media Access Control (MAC) apparatus, comprising:
parsing an input frame to generate a control signal;
receiving transmission and receipt data;
generating a frame on the basis of the transmission and receipt data according to the generated control signal; and
outputting the generated frame.

18. The method of claim 17, wherein the parsing of the input comprises at least one of:
parsing a structure of the input frame to generate the control signal;
parsing a header field of the input frame to generate the control signal; and
parsing a payload field of the input frame to generate the control signal.
